(19) United States
(12) Patent Application Publication
(10) Pub. No.: US 2004/0084912 A1
(43) Pub. Date: May 6, 2004

(54) Tool for sandwich cookie dunking

(76) Inventor: Dino A. Palmieri, East Rockaway, NY (US)

Correspondence Address: George Likourezos, Esq., Carter, DeLuca, Farrell & Schmidt, LLP, Suite 225, 445 Broad Hollow Road, Melville, NY, 11747, US

(21) Appl. No.: 10/285,096

(22) Filed: Oct. 31, 2002

(51) Int. Cl. A47J 43/28

(52) U.S. Cl. 294/1.1

(57) ABSTRACT

A tool for sandwich cookie dunking is provided having a handle and a sandwich cookie supporting element, located at a distal end of the handle, for supporting a sandwich cookie of the type having a top and bottom crust and cream filling therebetween. The sandwich cookie, after being held in place by the sandwich cookie supporting element, can be dunked in a glass of milk or other substance, without getting a user's fingers wet.

### FIELD OF THE INVENTION

This present invention relates to a tool for use in connection with cookie dunking. In particular, the invention relates to a tool having a handle or a shaft and a sandwich cookie supporting element, located at a distal end of the handle, for supporting a sandwich cookie.

### BACKGROUND OF THE INVENTION

Children, as well as adults, enjoy eating sandwich cookies, such as OREO™ cookies, with milk. The sandwich cookie is typically held by one's fingers and a portion thereof dunked or submerged into a glass of milk. After being submerged into the glass of milk for several seconds to a few minutes, the portion of the sandwich cookie which has been submerged in the glass of milk is then bitten by the individual. The individual then submerges a remaining portion of the cookie into the glass of milk and repeats the process, until a small piece of the sandwich cookie is left which is then eaten by the individual.

The process of dunking sandwich cookies in milk as discussed above has several disadvantages. First, the individual is likely to get his fingers wet with the milk in the glass. Second, the individual cannot get the last, small piece of sandwich cookie dunked without getting his fingers wet with the milk in the glass. Accordingly, the individual is likely to eat the last, small piece of sandwich cookie without dunking it into the glass of milk.

Finally, another disadvantage of the above process is that the individual cannot enjoy drinking the milk while eating the sandwich cookie. This is because if the glass of milk becomes less than three-quarters full, the individual is not able to easily dunk the sandwich cookie into the milk. The individual must tilt the glass of milk to be able to dunk the sandwich cookie, which often leads to milk spills in the case of children, or the individual must refill the glass with additional milk, which is often leftover in the glass.

Hence, a tool for sandwich cookie dunking is needed which allows an individual to dunk a sandwich cookie in a glass of milk and eat the sandwich cookie which overcomes the disadvantages discussed above.

### SUMMARY

An aspect of the present invention is to provide a sandwich cookie dunking tool. This invention achieves this and other aspects by providing the tool of the present invention as described herein.

The tool of the present invention includes a handle or a shaft and a sandwich cookie supporting element, located at a distal end of the handle, dimensioned and configured for supporting a sandwich cookie of the type having a top and bottom crust and cream filling therebetween, such as an OREO™ cookie.

### BRIEF DESCRIPTION OF THE FIGURES

FIG. 1 is a perspective view of the tool for sandwich cookie dunking according to a first embodiment of the present invention;

FIGS. 2A and 2B are perspective views of the tool for sandwich cookie dunking according to the first embodiment showing the tool in use;

FIG. 3 is a perspective view of the tool for sandwich cookie dunking according to a second embodiment of the present invention; and

FIG. 4 is a perspective view of the tool for sandwich cookie dunking according to the second embodiment showing the tool in use.

### DETAILED DESCRIPTION OF THE INVENTION

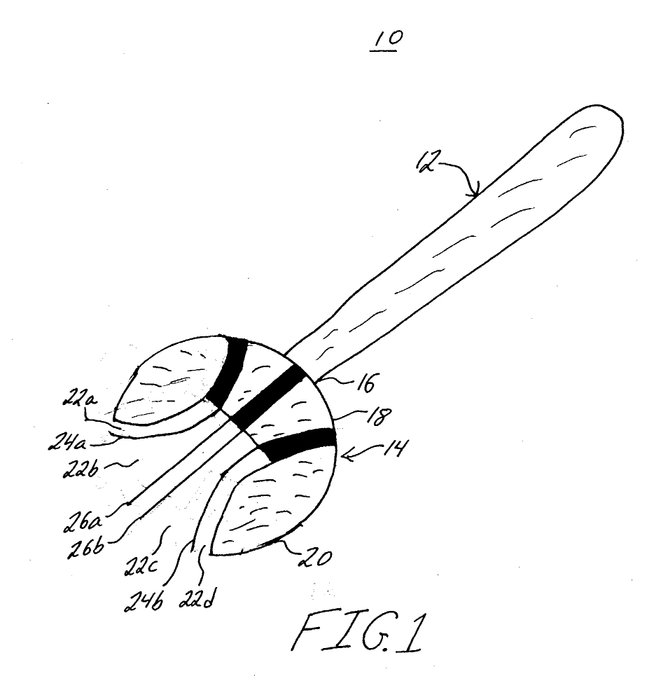

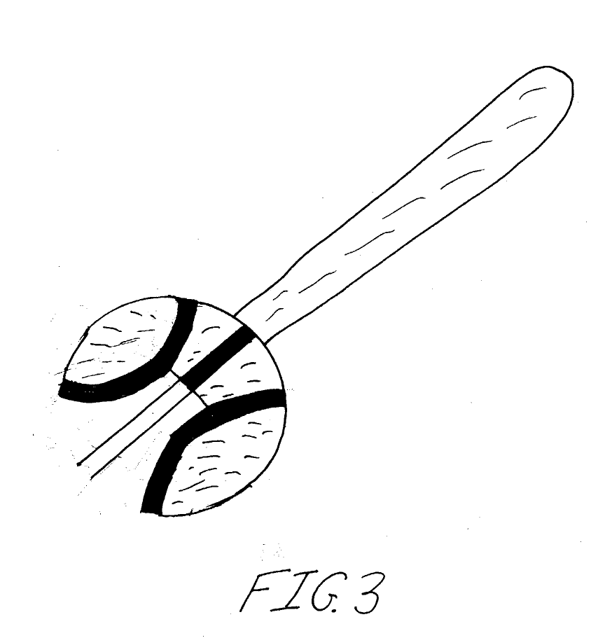

With reference to FIG. 1, there is shown a perspective view of a tool for sandwich cookie dunking according to a first embodiment of the present invention. The tool designated generally by reference numeral 10 includes a handle or a shaft 12 and a sandwich cookie supporting element 14, located at a distal end 16 of the handle 12, for supporting a sandwich cookie 100 of the type having a top and bottom crust 102, 104 and cream filling 106 therebetween (see FIG. 3A). The shaft 12 is preferably in the range of 15 to 20 centimeters, in order for a proximal portion of the shaft 12 to extend outside a glass when the tool 10 is used to dunk a sandwich cookie.

The sandwich cookie supporting element 14 is flat and circular-shaped and includes a proximal portion 18 and a distal portion 20. The distal portion 20 includes four concave-shaped symmetrical grooves 22a, 22b, 22c, 22d (i.e., two outermost, concave-shaped symmetrical grooves 22a, 22d and two innermost, concave-shaped symmetrical grooves 22b, 22c). The two outermost concave-shaped symmetrical grooves 22a, 22d are defined by a respective C-shaped rim 24a, 24b extending from the proximal portion 18 of the sandwich cookie supporting element 14. Two longitudinal extensions 26a, 26b also extend from the proximal portion separating and defining the two innermost concave-shaped symmetrical grooves 22b, 22c. The grooves 22a, 22b, 22c, 22d, the rims 24a, 24b and longitudinal extensions 26a, 26b are symmetrical with respect to a central, longitudinal axis of the sandwich cookie supporting element 14.

The two grooves 22b, 22c adjacent to the two longitudinal extensions 26a, 26b are dimensioned and configured for receiving either the top or bottom crust 102, 104 of the sandwich cookie 100. Preferably, the two innermost grooves 22b, 22c can extend horizontally from three to five millimeters (due to flexing of C-shaped rims 24a, 24b), in order for the tool 10 to be able to support most sandwich cookies, such as OREO™ cookies which have top and bottom crusts having a cross-section of approximately four millimeters.

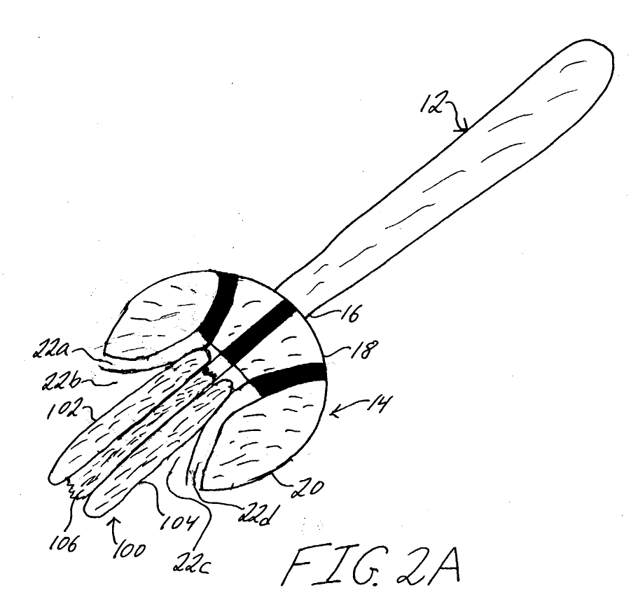

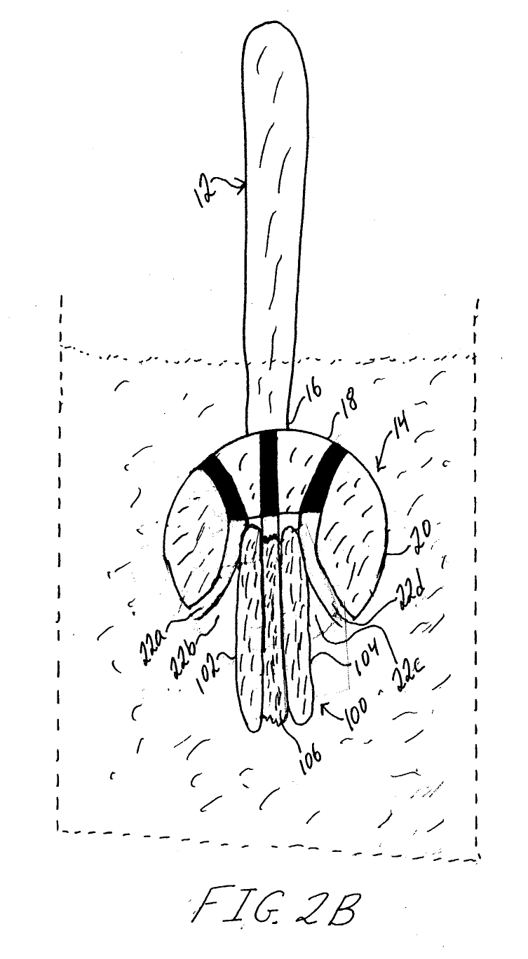

The two longitudinal extensions 26a, 26b are dimensioned and configured for aligning and penetrating the cream filling 106 of the sandwich cookie 100, as shown by FIG. 2A. As the cream filling 106 is penetrated by the two longitudinal extensions 26a, 26b, the cream filling 106 encapsulates each of the two longitudinal extensions 26a, 26b to provide a strong hold on the sandwich cookie 100.

The sandwich cookie 100, after being held in place by the sandwich cookie supporting element 14, can be dunked in a glass of milk or other substance, without getting a user's fingers wet, as shown by FIG. 2B. Further, the entire sandwich cookie 100 can be dunked in one dunking motion, as opposed to the process described above where only a portion of the cookie 100 can be dunked during each dunking motion if the individual does not want to get his fingers' wet. Additionally, with reference to FIG. 2B, the individual does not have to keep his glass filled to a certain level, in order to be able to dunk his sandwich cookie 100, since the long handle 12 enables the sandwich cookie 100 to reach the entire length of the glass (shown by the dotted lines in FIG. 2B).

A region 28 of the proximal portion 18 aligned with the two longitudinal extensions 26a, 26b, and regions 30a, 30b of the proximal portion 18 aligned with the two outermost, concave-shaped grooves 22a, 22d are engraved or colored (e.g., black), such that the sandwich cookie supporting element 14 resembles a flat basketball when observed from a top or bottom plan (see FIG. 1).

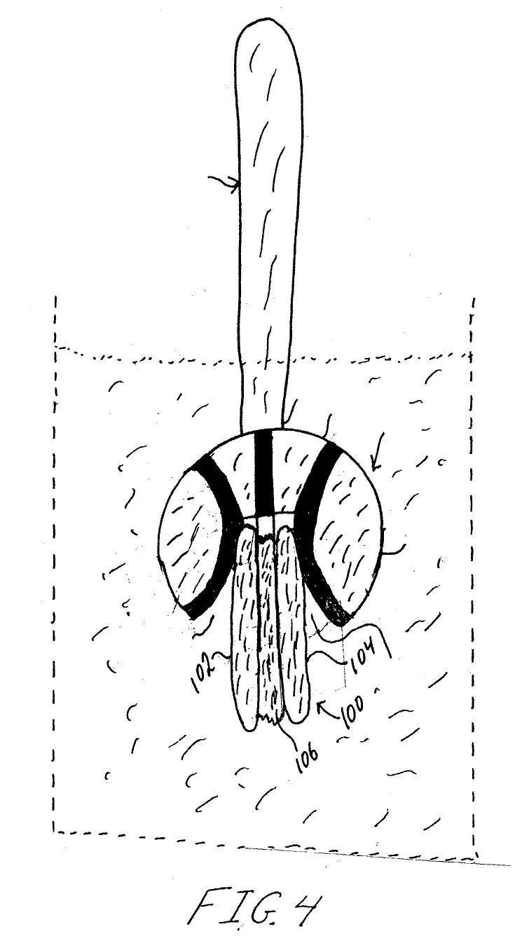

With reference to FIG. 3, there is shown a second embodiment of the tool for sandwich cookie dunking according to the present invention. The tool designated generally by reference numeral 40 includes a handle or a shaft 42 and a sandwich cookie supporting element 44, located at a distal end 46 of the handle 42, for supporting a sandwich cookie 100 of the type having a top and bottom crust 102, 104 and cream filling 106 therebetween (see FIG. 4). The shaft 42 is preferably in the range of 15 to 20 centimeters, in order for a proximal portion of the shaft 42 to extend outside a glass when the tool 40 is used to dunk a sandwich cookie.

The sandwich cookie supporting element 44 is flat and circular-shaped. The sandwich cookie supporting element 44 includes a proximal portion 48 and a distal portion 50. The distal portion 50 includes two concave-shaped symmetrical grooves 52a, 52b and two longitudinal extensions 54a, 54b with respect to a central, longitudinal axis of the sandwich cookie supporting element 44.

The two grooves 52a, 52b are dimensioned and configured for receiving either the top or bottom crust 102, 104 of the sandwich cookie100. Preferably, the two grooves 52a, 52b have a horizontal length ranging from three to five millimeters, in order for the tool 40 to be able to support most sandwich cookies, such as OREO™ cookies which have top and bottom crusts having a cross-section of approximately three millimeters.

The two longitudinal extensions 54a, 54b are dimensioned and configured for aligning and penetrating the cream filling 106 of the sandwich cookie 100, as shown by FIG. 4. As the cream filling 106 is penetrated by the two longitudinal extensions 54a, 54b, the cream filling 106 encapsulates each of the two longitudinal extensions 54a, 54b to provide a strong hold on the sandwich cookie 100.

The sandwich cookie 100, after being held in place by the sandwich cookie supporting element 44, can be dunked in a glass of milk or other substance, without getting a user's fingers wet, as shown by FIG. 4. Further, the entire sandwich cookie 100 can be dunked in one dunking motion, as opposed to the process described above where only a portion of the cookie 100 can be dunked during each dunking motion if the individual does not want to get his fingers' wet. Additionally, with reference to FIG. 4, the individual does not have to keep his glass filled to a certain level, in order to be able to dunk his sandwich cookie 100, since the long handle 42 enables the sandwich cookie 100 to reach the entire length of the glass (shown by the dotted lines in FIG. 4).

A region 56 of the proximal portion 48 aligned with the two longitudinal extensions 54a, 54b, and regions 58a, 58b of the proximal portion 48 as well as regions 60a, 60b adjacent to the two concave-shaped grooves 52a, 52b and aligned with regions 58a, 58b are engraved or colored (e.g., black), such that the sandwich cookie supporting element 44 resembles a flat basketball when observed from a top or bottom plan, as with the first embodiment.

The handle and sandwich cookie supporting element of the first and second embodiments are preferably unitary (i.e., one piece) and made from a metallic alloy, such as stainless steel. The tool of the first and second embodiment can also be made from polymers or plastics. In the case of the first embodiment, the polymer construction provides flexing of innermost C-shaped rim of each pair of C-shaped rims 24a, 24b as the cookie top or bottom 102, 104 is inserted within the concave-shaped grooves 22b, 22c for improved gripping and holding of the sandwich cookie 100.

What has been described herein is merely illustrative of the application of the principles of the present invention. Other arrangements and methods, such as configuring and designing the sandwich cookie supporting elements 14 and 44 to be spherical, triangular, rectangular, etc. or to resemble other flat balls, e.g., a tennis ball, a baseball, a softball, a football, a soccer ball, a bowling ball, a golf ball, etc., and/or to illustrate images thereon, e.g., a happy face, a steering wheel, the peace sign, a corporate logo, names, etc., may be implemented by those skilled in the art without departing from the scope and spirit of this invention.

We claim:

1. A tool for sandwich cookie dunking comprising:
a handle; and
a sandwich cookie supporting element extending from the handle and being dimensioned and configured for supporting a sandwich cookie, where the sandwich cookie supporting element defines at least one groove having a variable length substantially throughout and configured for receiving therein one of a top and bottom crust of the sandwich cookie, and where the sandwich cookie supporting element includes at least one extension adjacent to the at least one groove configured to penetrate a cream filling of the sandwich cookie, wherein the sandwich cookie is supported by the tool.

2. The tool according to claim 1, wherein the sandwich cookie supporting element is flat and circular-shaped having a front and back face.

3. The tool according to claim 2, wherein the front and back faces are configured in order for the sandwich cookie supporting element to resemble a ball selected from the group consisting of a tennis ball, a baseball, a basketball, a softball, a football, a soccer ball, a bowling ball, and a golf ball.

4. The tool according to claim 1, wherein the sandwich cookie supporting element includes a proximal portion and a distal portion, wherein the distal portion includes the at least one groove and the at least one extension, and wherein the at least one extension extends from the proximal portion.

5. The tool according to claim 1, wherein the sandwich cookie supporting element is symmetrical with respect to a central, longitudinal axis of the tool.

6. The tool according to claim 1, wherein the tool is one of metallic and plastic.

7. The tool according to claim 1, wherein at least one edge of the sandwich cookie supporting element defining the at least one groove is configured to flex upon receipt within the at least one groove of one of the top and bottom crust of the sandwich cookie.

8. The tool according to claim 1, wherein the at least one groove is arced on at least one side.

9. A tool for sandwich cookie dunking comprising:
a handle; and
a sandwich cookie supporting element extending from the handle and being dimensioned and configured for supporting a sandwich cookie, where the sandwich cookie supporting element defines at least one groove having an arced configuration configured for receiving therein one of a top and bottom crust of the sandwich cookie, and where the sandwich cookie supporting element includes at least one extension adjacent to the at least one groove configured to penetrate a cream filling of the sandwich cookie, wherein the sandwich cookie is supported by the tool.

10. The tool according to claim 9, wherein the sandwich cookie supporting element is flat and circular-shaped having a front and back face.

11. The tool according to claim 10, wherein the front and back faces are configured in order for the sandwich cookie supporting element to resemble a ball selected from the group consisting of a tennis ball, a baseball, a basketball, a softball, a football, a soccer ball, a bowling ball, and a golf ball.

12. The tool according to claim 9, wherein the sandwich cookie supporting element includes a proximal portion and a distal portion, wherein the distal portion includes the at least one groove and the at least one extension, and wherein the at least one extension extends from the proximal portion.

13. The tool according to claim 9, wherein the sandwich cookie supporting element is symmetrical with respect to a central, longitudinal axis of the tool.

14. The tool according to claim 9, wherein the tool is one of metallic and plastic.

15. The tool according to claim 9, wherein at least one edge of the sandwich cookie supporting element defining the arced configuration is configured to flex upon receipt within the at least one groove of one of the top and bottom crust of the sandwich cookie.

16. A tool for sandwich cookie dunking comprising:
a handle; and
a sandwich cookie supporting element extending from the handle and being dimensioned and configured for supporting a sandwich cookie, where the sandwich cookie supporting element defines at least two grooves each having a variable length substantially throughout and symmetrically aligned with respect to a central, longitudinal axis of the tool, each of the at least two grooves being dimensioned and configured for receiving therein one of a top and bottom crust of the sandwich cookie, and where the sandwich cookie supporting element includes at least one extension adjacent to at least one of the at least two grooves configured to penetrate a cream filling of the sandwich cookie, wherein the sandwich cookie is supported by the tool.

17. The tool according to claim 16, wherein the sandwich cookie supporting element is flat and circular-shaped having a front and back face.

18. The tool according to claim 17, wherein the front and back faces are configured in order for the sandwich cookie supporting element to resemble a ball selected from the group consisting of a tennis ball, a baseball, a basketball, a softball, a football, a soccer ball, a bowling ball, and a golf ball.

19. The tool according to claim 16, wherein the sandwich cookie supporting element includes a proximal portion and a distal portion, wherein the distal portion includes the at least two grooves and the at least one extension, and wherein the at least one extension extends from the proximal portion.

20. The tool according to claim 16, wherein at least two edges of the sandwich cookie supporting element defining the at least two grooves are configured to flex upon receipt within the at least two grooves of one of the top and bottom crust of the sandwich cookie.

21. A tool for sandwich cookie dunking comprising:
a handle; and
a sandwich cookie supporting element extending from the handle and being dimensioned and configured for supporting a sandwich cookie.

22. The tool according to claim 21, wherein the sandwich cookie is an OREO™-type sandwich cookie.
